(19) United States
(12) Patent Application Publication
(10) Pub. No.: US 2003/0222140 A1
(43) Pub. Date: Dec. 4, 2003

(54) Cash register assembly

(76) Inventor: Paul J. Wasson, Lake In The Hills, IL (US)

Correspondence Address: Timothy M. Kelley, Michael Best & Friedrich LLP, 100 East Wisconsin Avenue, Milwaukee, WI, 53202-4108, US

(21) Appl. No.: 10/162,439

(22) Filed: Jun. 4, 2002

(51) Int. Cl. G06K 15/00

(52) U.S. Cl. 235/383

(57) ABSTRACT

A cash register assembly including an electronic device, a peripheral device and a cable connecting the devices, the assembly including a housing defining an internal recess and an opening communicating with the internal recess, an inner wall engaged with the housing and extending along one of the top, bottom and side walls to define therebetween a cable guide channel extending toward the opening and the back wall and being adapted to receive a portion of the cable, a front panel removably secured to the housing in a position overlying the opening to afford selective access to the recess, and at least one aperture located in one of the top, bottom, side and back walls and communicating between the exterior of the housing and the internal recess adjacent the cable guide channel.

### BACKGROUND OF THE INVENTION

1. Technical Field

The invention relates to point of sale cash registers, and more particularly to an electronic point of sale cash register assembly.

2. Background Information

Point of sale cash registers have long been used by retail stores to record sales and to calculate and facilitate the various monetary transactions associated with retail item purchases, returns, exchanges, and the like. The point of sale cash register, like many other devices, has benefited greatly from the increased incorporation of microprocessors and computers into the assembly. In this regard, cash registers generally include various electronic peripheral devices such as monitors, keyboards, scanners, printers and the like. It is known to provide such devices as components so that in the event an individual component fails, the failed component may be individually replaced without effecting the other components.

In addition to the various peripheral items mentioned above, a central processing module is provided to coordinate the various operations and input and output functions of the peripheral devices. This function is typically provided by personal computers (“PCs”). Utilization of PCs provides a flexible and expandable point of sale cash register that may easily be upgraded and improved as PC technology advances.

### SUMMARY OF THE INVENTION

In view of the foregoing, it is apparent that a point of sale cash register adapted to be controlled by a PC and including a plurality of independent peripherals that may be easily replaced is desirable. One of the problems associated with known cash registers, however, is that gaining access to the PC or changing connections between the PC and peripheral devices can be difficult. This is particularly the case in circumstances wherein the assembly is located at a point of sale restricting access to the assembly from all sides. In such circumstances, the assembly must be moved to gain access to the PC.

Another problem with some know register designs is the management of cabling connection the PC to peripheral devices. Depending on the number and nature of the peripheral devices associated with the assembly, the cabling can be extensive.

To address these concerns with known point of sale cash register systems, the invention provides a cash register assembly that improves service access and maintenance of the assembly and associated PC and peripheral devices. In particular, the invention provides a cash register assembly having a front panel access, which is usually not obstructed in typical point of sale arrangements. Also, the cash register assembly provides a housing that permits the PC removed and/or installed easily without extensive re-cabling of the assembly. The cash register assembly also provides one or more cable management channels that permit the cables to be routed in an organized manner on the interior of the housing.

In one embodiment, the invention provides a cash register assembly including an electronic device, a peripheral device and a cable connecting the devices. The assembly includes a housing having top, bottom, side and back walls and defining an internal recess and an opening communicating with the internal recess, the opening and the recess being adapted to receive the electronic device. The assembly also includes an inner wall engaged with the housing and extending along one of the top, bottom and side walls to define therebetween a cable guide channel extending toward the opening and the back wall and being adapted to receive a portion of the cable. The assembly also includes a front panel removably secured to the housing in a position overlying the opening to afford selective access to the recess. The assembly also includes at least one aperture located in one of the top, bottom, side and back walls and communicating between the exterior of the housing and the internal recess adjacent the cable guide channel and the back wall, the aperture being adapted to receive the cable.

In another embodiment, the invention provides a point of sale cash register assembly including a housing including a back wall, a plurality of lateral walls extending from the back wall and defining with the back wall an interior recess. The housing also defines an opening spaced from the back wall and communicating with the interior recess. The housing also includes a front wall removably mounted on one of the plurality of the lateral walls in a position closing the opening and an inner wall extending into the interior recess and along one of the lateral walls, the inner wall and the lateral wall defining therebetween a cable guide channel. The housing also includes an aperture in one of the lateral walls adjacent the back wall and the cable guide channel. The assembly also includes an electronic hardware device received by the housing and located adjacent the inner wall and including a port facing the front wall. The assembly also includes a peripheral device located outside of the housing and at least one cable having an end engaged with the port, a length extending along the cable guide channel and through an aperture and an end connected to the peripheral device.

In another embodiment, the invention provides a point of sale cash register assembly including a housing including a back wall, a plurality of lateral walls extending from the back wall and defining with the back wall an interior recess and an opening spaced from the back wall and communicating with the interior recess. The housing also includes a front wall removably mounted on one of the plurality of the lateral walls in a position closing the opening and a pair of spaced apart inner walls. Each inner wall extends into the interior recess along a respective one of the lateral walls, each inner wall and respective lateral wall defining therebetween a respective cable guide channel. The housing also includes an aperture in one of the lateral walls adjacent the back wall and adjacent one of the cable guide channels. The assembly also includes an electronic hardware device received by the housing and located between the inner walls and including a port facing the front wall. The assembly also includes a peripheral device located outside of the housing and at least one cable having an end engaged with the port, a length extending along the cable guide channel and through an aperture and an end connected to the peripheral device.

Other features and advantages of the invention will become apparent to those skilled in the art upon review of the following detailed description and drawings.

### BRIEF DESCRIPTION OF THE DRAWINGS

FIG. 1 is a perspective view of a point of sale cash register assembly embodying the invention.

FIG. 2 is a view similar to FIG. 1 with a portion of the assembly cut away.

FIG. 3 is an exploded perspective view of the assembly shown in FIG. 1.

FIG. 4 is a second perspective view of the assembly shown in FIG. 1 with a front panel partially open.

FIG. 5 is an elevational view of the assembly shown in FIG. 1 with a portion cut away.

FIG. 6 is a top view of the assembly shown in FIG. 1 with a portion cut away.

FIG. 7 is a third perspective view of the assembly shown in FIG. 1 with a portion cut away.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items.

### DETAILED DESCRIPTION OF THE PREFERRED EMBODIMENT

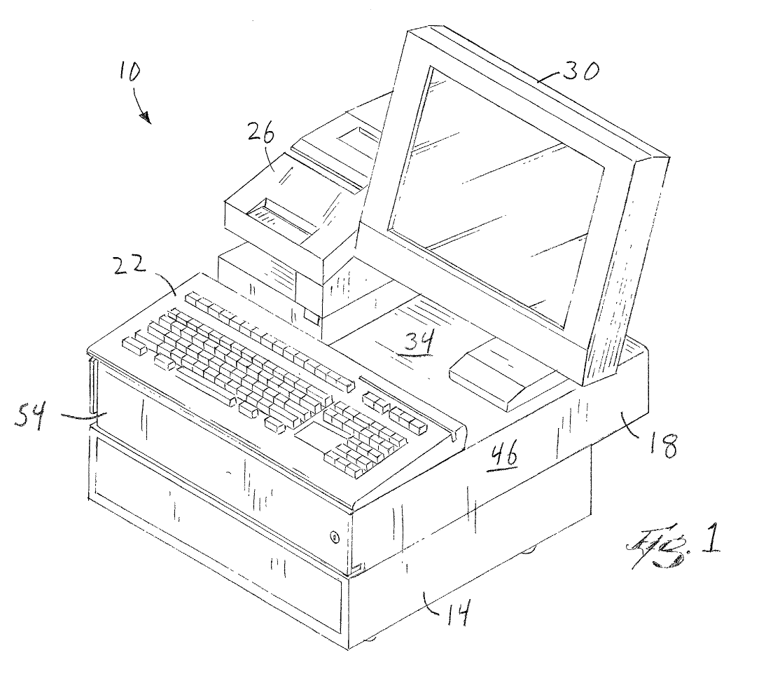

The drawings illustrate a point of sale cash register assembly 10 embodying the present invention. Referring first to FIG. 1, the cash register 10 includes a cash drawer 14, a housing 18, a keyboard 22, a printer 26, and a monitor 30. Generally, the printer 26 and the monitor 30 are positively secured to the housing 18, however the printer 26 and monitor 30 may also simply rest upon the housing 18. The keyboard 22 is generally not positively secured to the housing 18 such that the keyboard 22 may be moved to a convenient location for typing and data entry.

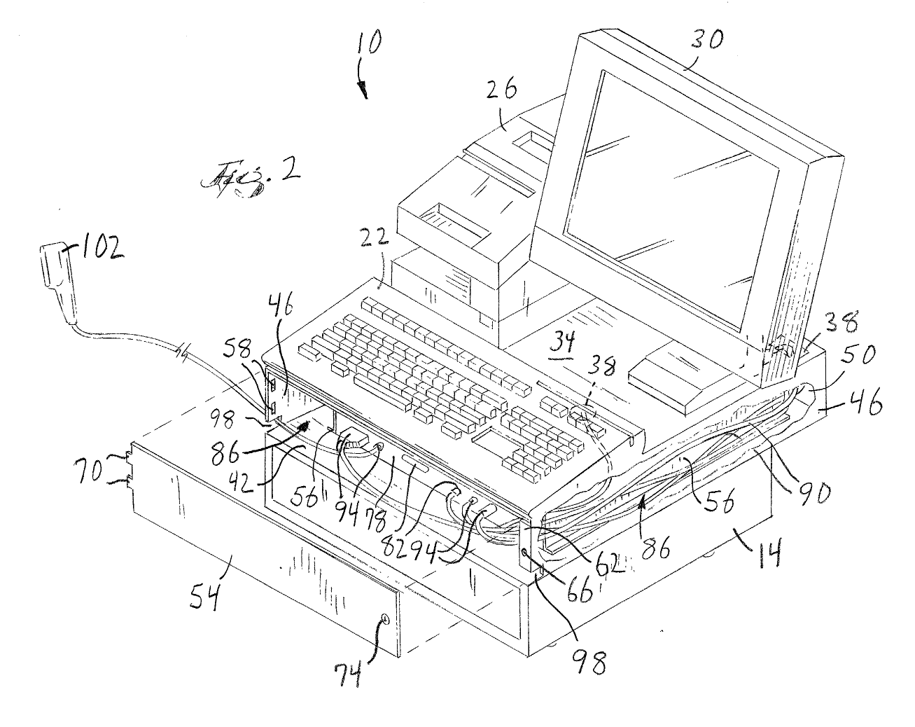

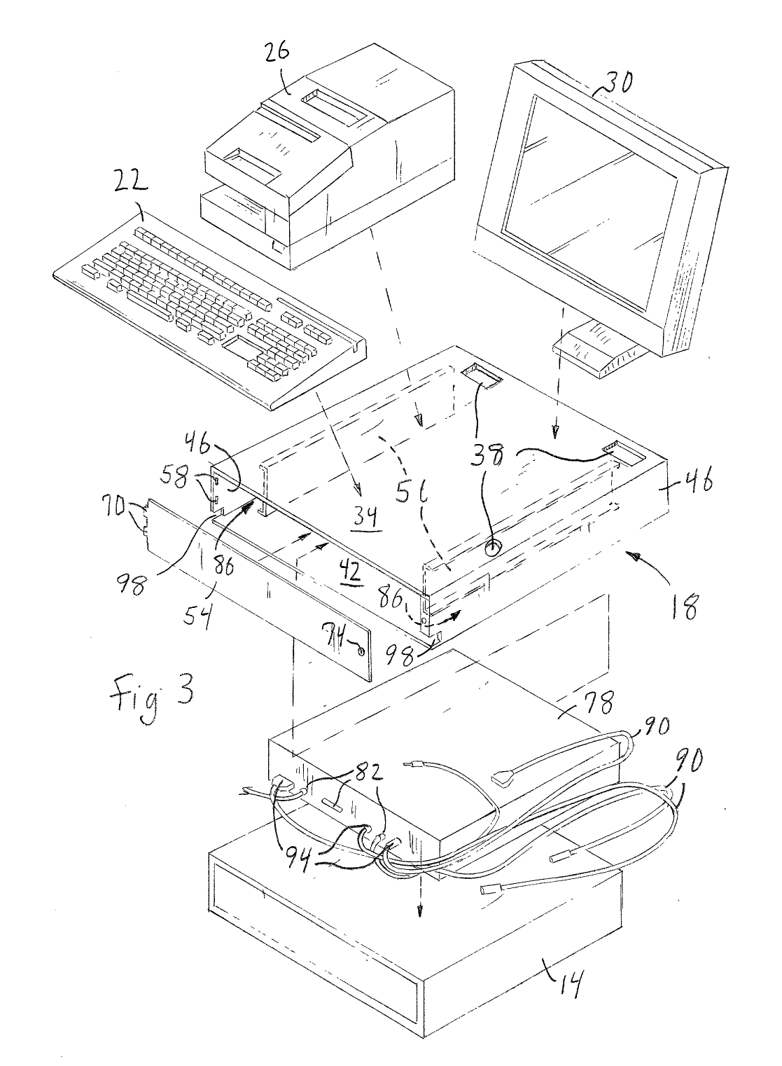

Referring now to FIGS. 2-5, the housing 18 includes a top wall 34 including a plurality of apertures 38, and a bottom wall 42 that rests upon the cash drawer 14 and is opposed to the top wall 34. The housing 18 also includes opposed side walls 46 extending between the top and bottom walls 34, 42 and a back wall 50 that extends between the top and bottom walls 34, 42 as well as the opposed side walls 46. The top wall 34, the bottom wall 42, the side walls 46, and the back wall 50 cooperate to define an internal recess within the housing 18 and a front opening that communicates with the internal recess. A front panel 54 is removably securable to one or more of the walls (e.g. the side walls 46 as illustrated) and, when thus secured, extends between the side walls 46 and top and bottom walls 34, 42 and overlies the opening. A pair of opposed inner walls 56 (FIG. 3) are inwardly spaced from and substantially parallel to the side walls 34, 42, and extend between the top and bottom walls 34, 42. The inner walls 56 do not fully extend between the front panel 54 and the back wall 50 for reasons that will become apparent below.

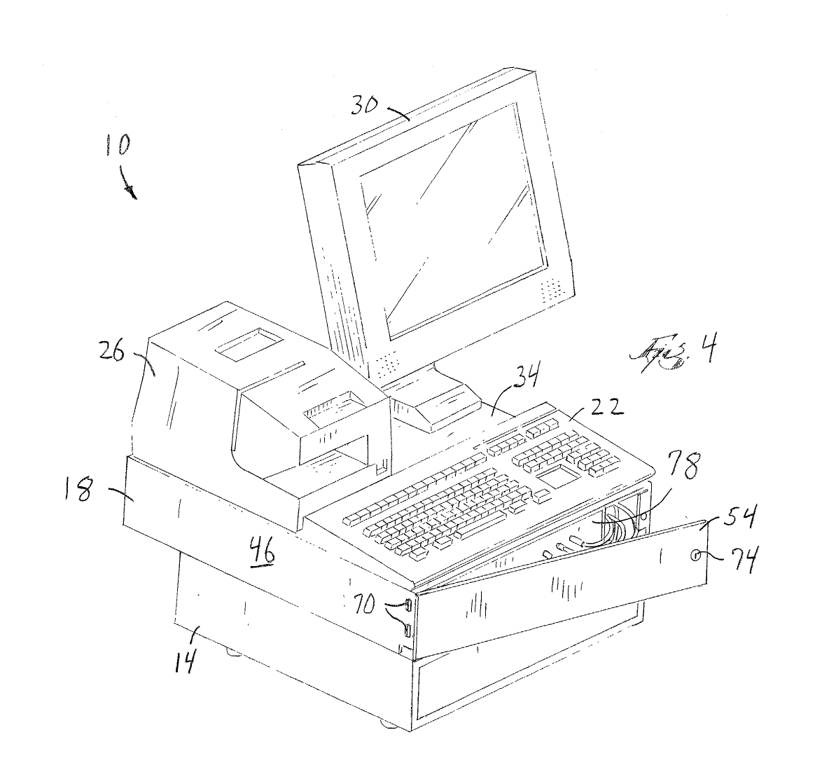

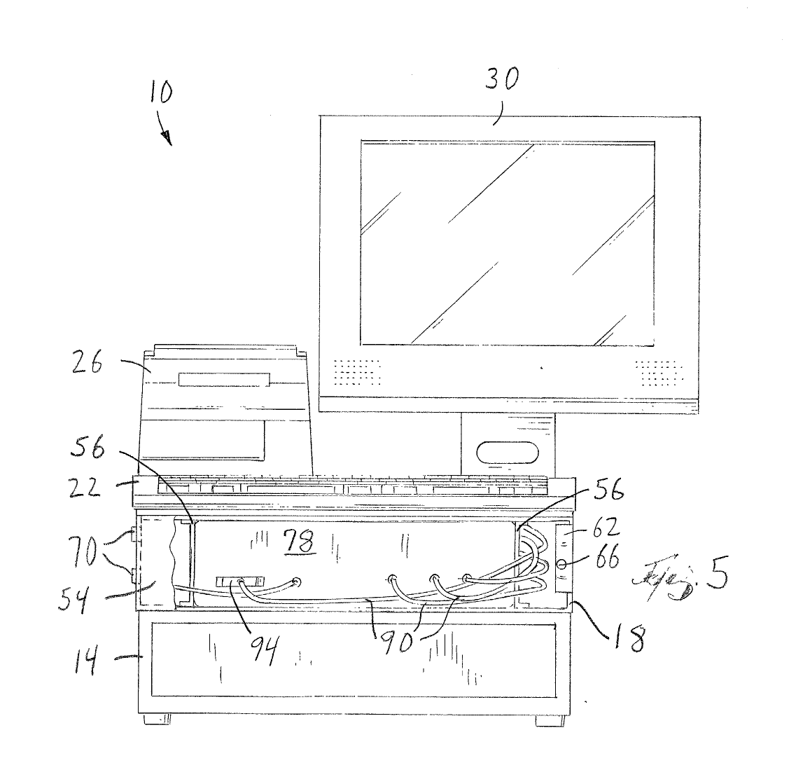

One side wall 46 includes a pair of notches or slots 58 positioned near the front portion of the housing 18, and the other side wall 46 includes a flap portion 62 that is substantially perpendicular to the remainder of the side wall 46 and is also formed near the front portion of the housing. The flap portion 62 also includes an aperture 66. The front panel 54 includes a pair of protrusions 70 (FIG. 5) that are received by the notches 58 to secure one side of the panel 54 to the respective side wall 46 (FIG. 4). The other side of the front panel 54 includes a locking assembly 74. The locking assembly 74 is receivable by the aperture 66 and is operable to lockingly secure the panel 54 to the housing 18. It should be apparent to one of ordinary skill in the art that the panel 54 could also be removably secured to the top and bottom walls 34, 42 in a similar manner.

The housing 18 is configured to receive and house an electronic hardware unit such as a central processing unit (“CPU”) 78 of a personal computer. The CPU 78 includes a plurality of ports 82 along at least one side and contains various microprocessors and other electronic devices that are well known in the computing industry. The CPU 78 preferably includes, among other things, a 370 socket, 700 MHz or greater processor, an INTEL® 815E motherboard chip set having an NLX or equivalent form factor, a 192 KB or greater L2 cache, 256 MB of DIMM memory (preferably upgradable to 512 MB) and a DVI video card with 4 MB or more of memory suitable for operating at 800×600 dpi. It will be readily understood, however that any suitable CPU having operating characteristics suitable for operation with the assembly 10 can be used. The ports 82 provide electrical communication between the electronic devices within the CPU 78 and the external components of the cash register 10. The ports 82 are of a variety of shapes, sizes, and configurations based upon the particular device they are intended to communicate with.

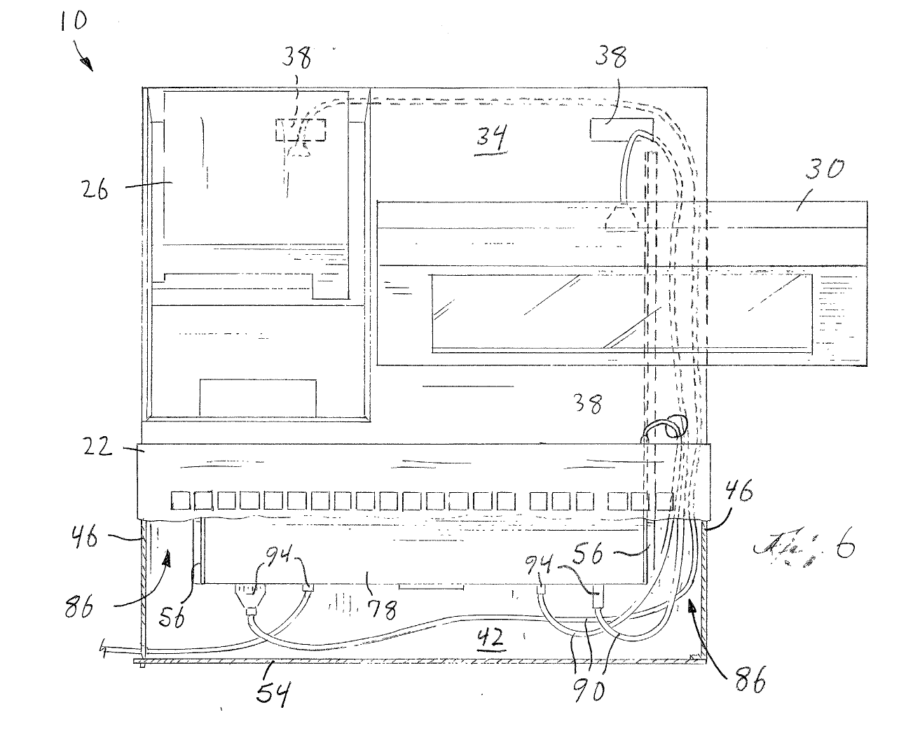

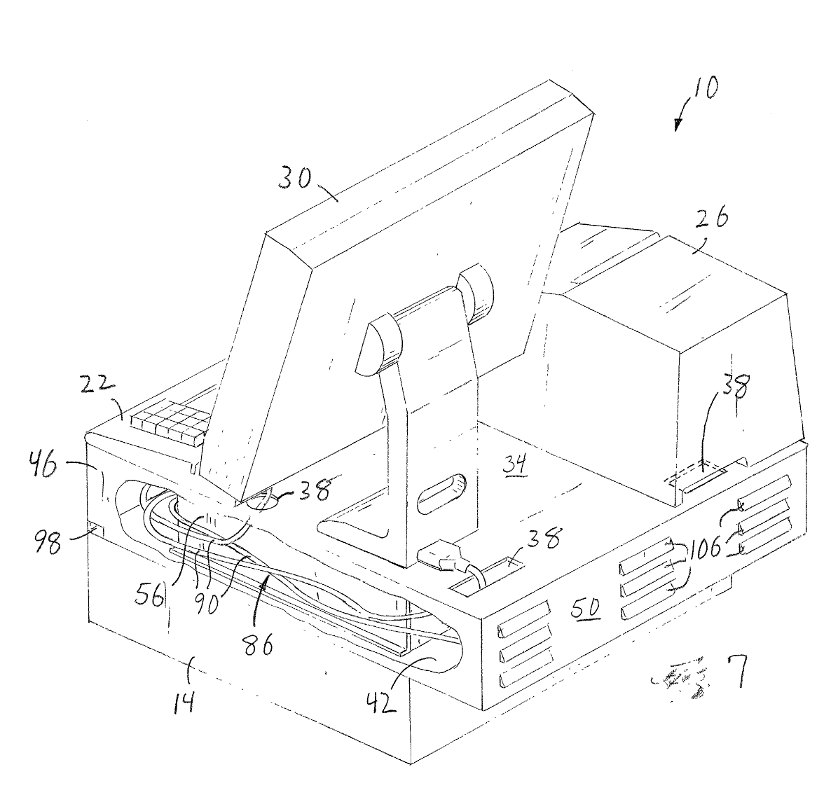

Referring to FIGS. 6 and 7, the inner walls 56 cooperate with respective side walls 46 to define a pair of cable-guiding channels 86 that each extend along the side portions of the housing 18 between one of the inner walls 56 and a respective adjacent side wall 46. The inner walls 56 are generally spaced from each other an appropriate distance such that the CPU 78 is closely received therebetween. Alternative embodiments of the invention may include a single inner wall 56 that provides a single cable-guiding channel 86. In this respect, the CPU 78 would be closely received between the single inner wall 56 and one of the side walls 46, and the cable-guiding channel 86 would be defined by the single inner wall 56 and the other side wall 46. Regardless of the inner wall 56 configuration, the CPU 78 is inserted into the housing such that the ports 82 face toward the front panel 54. Cables 90 including plugs 94 adapted for insertion into various individual ports 82 are coupled to the ports 82 such that the cables 90 extend toward the front panel 54. The cables 90 are routed through one or more of the cable-guiding channels 86 toward the back wall 50 and are then extended through an appropriate aperture 38 in the top wall 34. The cables 90 are coupled to their respective components, thereby providing electronic communication between the components and the CPU 78. The CPU 78 also communicates with the cash drawer 14 to control the opening of the cash drawer 14. While substantially all of the cables 90 are illustrated as being routed along only one of the cable-guiding channels 86, it should be readily apparent that both channels 86 may be used as required.

As illustrated, the apertures 38 are positioned in the top wall 34 such that substantially no cables extend between the two inner walls 56. For example the apertures 38 that are provided for the monitor 30 and the printer 26 are positioned substantially adjacent to the back wall 50. As mentioned above, the inner walls 56 preferably do not extend all the way to the back wall 50 such that the cables 90 may be routed through the cable guiding channels 86 and then along the back wall 50, where they are subsequently extended through the apertures 38 and connected with the monitor and the printer. If the inner walls 56 do extend all the way to the back wall 50, holes or knock-outs should be provided in the inner walls 56 to allow the cables 90 to pass therethrough. In the same respect, the aperture 38 that is provided for the keyboard 22 preferably communicates directly with the cable guiding channel 86, such positioning of the apertures 38 with respect to the inner walls 56 provides a simple, well organized routing of the various cables 90.

In addition to the cable guiding channels 86, cutouts 98 may be provided in any of the walls such that additional components may be coupled to the CPU 78 for electronic communication therewith. The illustrated cutouts 98 are generally U-shaped, and are provided along a forward edge of each side wall 46. The cutouts 98 open toward the front of the housing 18 such that when the front panel 54 is secured to the housing 18, the cables 90 extending through the cutouts 98 are captured between the cutouts 98 and the front panel 54. The cutouts 98 are generally provided to allow hand-held components, such as the hand-held scanner 102 illustrated in FIG. 2, to be interconnected with the CPU 78. In addition to the cutouts 98, air vents 106 may be provided in any of the housing walls, such as the back wall 50 as illustrated. The air vents 106 afford additional air circulation through the housing 18 to cool the CPU 78.

The cash register 10 is advantageously configured to be easily serviceable. The positioning of the CPU 78 within the housing 18 and the routing of the cables 90 through the cable guiding channels 86 afford quick and easy access to the various ports 82 and plugs 94 of the CPU 78 and cables 90. In one aspect, if an individual component of the cash register 10 fails, the front panel 54 is removed and the faulty component is disconnected from the CPU 82. A new component may then be installed and either connected to the previously installed cable 90 or replaced by a new cable 90 that is routed along one of the cable-guiding channels 86 and out an appropriate aperture 38 or cutout 98 of the housing 18. Thus, there is generally no need to remove the entire CPU 78 at any time during servicing or replacement of an individual cash register component. In another aspect, the replacement of the entire CPU 78 is also facilitated. In this respect, the plugs 94 are disconnected from the ports 82 and the CPU 78 is removed from between the inner walls 56. A replacement CPU 78 is then inserted into the housing 18 and the plugs 94 are reconnected to the ports 82 of the replacement CPU 78. Thus the routing of the cables 90 through the housing 18, and the connections of the cables 90 to the components are not disturbed during replacement of the CPU 78.

Various features of the invention are set forth in the following claims.

What is claimed is:

1. A cash register assembly including an electronic device, a peripheral device and a cable connecting the devices, the assembly comprising:
a housing having top, bottom, side and back walls and defining an internal recess and an opening communicating with the internal recess, the opening and the recess being adapted to receive the electronic device,
an inner wall engaged with the housing and extending along one of the top, bottom and side walls to define therebetween a cable guide channel extending toward the opening and the back wall and being adapted to receive a portion of the cable,
a front panel removably secured to the housing in a position overlying the opening to afford selective access to the recess, and
at least one aperture located in one of the top, bottom, side and back walls and communicating between the exterior of the housing and the internal recess adjacent the cable guide channel and the back wall, the aperture being adapted to receive the cable.

2. An assembly as set forth in claim 1, wherein the top wall is adapted to support thereon the peripheral device.

3. An assembly as set forth in claim 1, wherein the at least one aperture is located in one of the side walls and is located adjacent the front wall.

4. An assembly as set forth in claim 1 and further including a cash drawer, and wherein the housing is supported by the cash drawer.

5. An assembly as set forth in claim 1, wherein at least one wall includes a ventilation aperture that allows air to flow through the housing to cool the electronic device.

6. An assembly as set forth in claim 1, and further including a second inner wall engaged with the housing and extending along one of the top, bottom and side walls to define therebetween a second cable guide channel extending toward the opening and the back wall and being adapted to receive a portion of a cable.

7. An assembly as set forth in claim 1 wherein the front panel has one end which is pivotally mounted on one of the side walls and has a second end which is releasably secured to the other of the side walls.

8. An assembly as set forth in claim 7 wherein the second end of the front panel is releasably secured to the other of the side walls by a fastener.

9. A point of sale cash register assembly comprising:
a housing including a back wall, a plurality of lateral walls extending from the back wall and defining with the back wall an interior recess and an opening spaced from the back wall and communicating with the interior recess, a front wall removably mounted on one of the plurality of the lateral walls in a position closing the opening, an inner wall extending into the interior recess and along one of the lateral walls, the inner wall and the lateral wall defining therebetween a cable guide channel, and an aperture in one of the lateral walls adjacent the back wall and the cable guide channel;
an electronic hardware device received by the housing and located adjacent the inner wall and including a port facing the front wall;
a peripheral device located outside of the housing; and
at least one cable having an end engaged with the port, a length extending along the cable guide channel and through an aperture and an end connected to the peripheral device.

10. A cash register assembly as set forth in claim 9 wherein the peripheral device is mounted on the housing.

11. A cash register assembly as set forth in claim 9 wherein at least one of the lateral walls includes a second aperture adjacent the front wall, and wherein a cable extends through the second aperture.

12. A cash register assembly as set forth in claim 9 further including a cash drawer and wherein the housing is mounted on the cash drawer.

13. A cash register assembly as set forth in claim 9 wherein at least one wall has a ventilation aperture that affords air flow through the housing.

14. A cash register assembly as set forth in claim 9 wherein the peripheral device is one of a keypad, a display unit, a printer, and a scanner.

15. A cash register assembly as set forth in claim 9 wherein the front panel is pivotally mounted on one of the lateral walls and is releasably secured to another of the lateral walls.

16. A cash register assembly as set forth in claim 9 wherein the front panel is releasably secured by a fastener.

17. A point of sale cash register assembly comprising:
a housing including a back wall, a plurality of lateral walls extending from the back wall and defining with the back wall an interior recess and an opening spaced from the back wall and communicating with the interior recess, a front wall removably mounted on one of the plurality of the lateral walls in a position closing the opening, a pair of spaced apart inner walls, each inner wall extending into the interior recess and along a respective one of the lateral walls, each inner wall and respective lateral wall defining therebetween a respective cable guide channel, the housing also including an aperture in one of the lateral walls adjacent the back wall and adjacent one of the cable guide channels;
an electronic hardware device received by the housing and located between the inner walls and including a port facing the front wall;
a peripheral device located outside of the housing; and
at least one cable having an end engaged with the port, a length extending along the cable guide channel and through an aperture and an end connected to the peripheral device.

18. A point of sale cash register assembly comprising:
a housing including a back wall, a pair of spaced apart side walls extending from the back wall, a top wall extending between the side walls and a bottom wall spaced from the top wall and extending between the side walls, the back wall, side walls, top wall and bottom wall defining an interior recess and an opening spaced from the back wall and communicating with the interior recess, a front wall mounted on one of the plurality of the lateral walls for selective movement between a first position closing the opening and a second position affording access to the recess, a pair of spaced apart inner walls, each inner wall having an end adjacent the opening and an opposite end adjacent the back wall and having a length extending between the opposite ends and along a respective side wall, each inner wall and respective side wall defining therebetween a respective cable guide channel, the housing also including an aperture in one of the top, bottom and side walls adjacent one of the cable guide channels;
an electronic hardware device received by the housing and located between the inner walls and including a port facing the opening;
a peripheral device located outside of the housing; and
a cable having an end engaged with the port, a length extending along the cable guide channel and through the aperture and an end connected to the peripheral device.
